(19) United States
(12) Patent Application Publication
(10) Pub. No.: US 2008/0251523 A1
(43) Pub. Date: Oct. 16, 2008

(54) Ventilation Device for a Fuel Container

(76) Inventors: Christian Krogull, Witten (DE); Knut Meyer, Essen (DE); Frank Reiter, Haan Rheinl (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/066,349

(22) PCT Filed: Sep. 7, 2006
(86) PCT No.: PCT/EP2006/066142

§ 371 Date: Jun. 4, 2008

(30) Foreign Application Priority Data
Sep. 14, 2005 (DE) 10 2005 043 888.1

(51) Int. Cl. B60K 15/035

(52) U.S. Cl. 220/746; 123/518

(57) ABSTRACT

A ventilation device (1) for a fuel container (2) with a liquid trap (3) and a suction jet pump (8) which is provided for emptying the liquid trap (3) has a filling-level limit switch (11) for detecting the filling level of fuel in the liquid trap (3). A valve (10) which is connected to the filling-level limit switch (11) is connected upstream of the suction jet pump (8). The suction jet pump (8) is first activated by means of the valve (10) when the intended filling level of fuel in the liquid trap (3) is exceeded.

### CROSS-REFERENCE TO RELATED APPLICATIONS

This application is a U.S. national stage application of International Application No. PCT/EP2006/066142 filed Sep. 7, 2006, which designates the United States of America, and claims priority to German application number 10 2005 043 888.1 filed Sep. 14, 2005, the contents of which are hereby incorporated by reference in their entirety.

### TECHNICAL FIELD

The invention relates to a ventilation device for a fuel container, with a liquid trap connected to at least one ventilation line and with a suction jet pump, arranged in the liquid trap, for the conveyance of fuel out of the liquid trap into the fuel container.

### BACKGROUND

Such ventilation devices are often used for ventilating the fuel container during refueling and during operation and are therefore known. Mostly, in present-day ventilation devices, ventilation lines lead from a bubbling container designed as a liquid trap to various sides of the fuel container and, if appropriate, to an activated charcoal filter. The suction jet pump is connected to a fuel pump arranged in the fuel container and sucks away fuel accumulated in the liquid trap and conveys it back into the fuel container. However, the constant connection of the suction jet pump to the fuel pump means that, even when the liquid trap is empty, the suction jet pump is in operation and fuel is conveyed unnecessarily through the suction jet pump. This contributes to a disturbing formation of foam in the fuel container and to an unnecessary energy consumption of the fuel pump.

### SUMMARY

A ventilation device of the type initially mentioned may be configured such that it avoids an unnecessary energy consumption for the suction jet pump and an unnecessary formation of foam in the fuel container. According to an embodiment, a ventilation device for a fuel container, may comprise a liquid trap connected to at least one ventilation line, a suction jet pump, arranged in the liquid trap, for the conveyance of fuel out of the liquid trap into the fuel container, and a valve connected to the suction jet pump, wherein the valve is switched as a function of the filling level of fuel in the liquid trap.

According to a further embodiment, a filling-level limit switch for switching the valve can be arranged in the liquid trap. According to a further embodiment, the filling-level limit switch may have a float. According to a further embodiment, the valve may be switched electrically. According to a further embodiment, the valve may have an electric actuator and a valve body movable against a valve seat is connected to the actuator. According to a further embodiment, the electric actuator may have an electromagnet or a piezo-element. According to a further embodiment, the filling-level limit switch may have an electrical contact. According to a further embodiment, the electrical contact of the filling-level limit switch may be arranged in series with the electric actuator of the valve. According to a further embodiment, the electrical contact of the filling-level limit switch and the electric actuator of the valve may be connected to a common electronic control unit. According to a further embodiment, a baffle provided for mounting in the fuel container may have an electromotive fuel pump, a conveying line of the fuel pump is connected to the suction jet pump, and the baffle may form with the liquid trap a structural unit. According to a further embodiment, the valve body of the valve can be guided movably toward a nozzle of the suction jet pump. According to a further embodiment, the valve can be arranged in the conveying line.

### BRIEF DESCRIPTION OF THE DRAWINGS

The invention permits numerous embodiments. To make its basic principal even clearer, one of these is illustrated in the drawing and is described below. In the drawing:

FIG. 1 shows diagrammatically a first embodiment of the ventilation device,

FIG. 2 shows diagrammatically a further embodiment of the ventilation device with an electronic control unit,

FIGS. 3, 4 show two embodiments of a valve of the ventilation device from FIG. 1 or 2 with a piezo-element,

FIGS. 5, 6 show two embodiments of the valve of the ventilation device from FIG. 1 or 2 with an electromagnet,

FIGS. 7, 8 show two embodiments of a completely mechanical valve of the ventilation device.

### DETAILED DESCRIPTION

According to various embodiments, the suction jet pump may be connected to a valve, and the valve can be switched as a function of the filling level of fuel in the liquid trap.

By virtue of this configuration, the suction jet pump can be switched off via the valve when no fuel has accumulated in the liquid trap. Only above a filling level provided can the valve be opened and the suction jet pump be supplied with fuel. It is thereby possible in a particularly simple way to avoid the situation where the suction jet pump is kept in operation when the liquid trap is empty. According to various embodiments, switching off the suction jet pump when the liquid trap is empty prevents an unnecessary energy consumption and an unnecessary formation of foam in the fuel container.

As a rule, it is sufficient to carry out the sucking away of the fuel from the liquid trap only when a filling level provided is reached. In this case, the ventilation device according to an embodiment has a particularly simple structural configuration when a filling-level limit switch for switching the valve is arranged in the liquid trap.

According to another embodiment, the filling-level limit switch has a particularly simple structural configuration when the filling-level limit switch has a float.

The control of the valve could, for example, take place completely mechanically, in that a valve body movable against a valve seat is connected to the float. However, according to another embodiment, the suction jet pump can be activated particularly reliably when the valve is switched electrically.

The valve can be manufactured particularly cost-effectively when the valve has an electric actuator and a valve body movable against a valve seat is connected to the actuator.

The electrically switched valve has a particularly simple structural configuration when the electric actuator has an electromagnet or a piezo-element.

According to another embodiment, the control of the electrically switched valve is particularly simple when the filling-level limit switch has an electrical contact. The electrical contact can open and close as a function of the filling level in the liquid trap.

According to another embodiment, the control outlay for switching the valve can be kept particularly low when the electrical contact to the filling-level limit switch is arranged in series with the electric actuator of the valve.

The ventilation device according to an embodiment allows a particularly versatile activation of the valve when the electrical contact to the filling-level limit switch and the electric actuator of the valve are connected to a common electronic control unit. In this case, for example, the activation of the valve may be absent at particularly low temperatures or when the internal combustion engine of the motor vehicle is started. In these cases, mostly, the entire fuel conveyed by the fuel pump is required for the internal combustion engine. The closing of the valve, which is possible by means of the electronic control unit, consequently prevents the situation where fuel is branched off to the suction jet pump of the liquid trap at low temperatures or when the internal combustion engine is started.

The mounting of the ventilation device according to an embodiment is particularly simple when a baffle provided for mounting in the fuel container has an electromotive fuel pump, when a conveying line of the fuel pump is connected to the suction jet pump, and when the baffle forms with the liquid trap a structural unit. Preferably, the baffle is fastened to the liquid trap.

According to another embodiment, the valve and the suction jet pump can be assembled to form a particularly compact unit when the valve body of the valve is guided movably toward a nozzle of the suction jet pump. It thereby becomes possible for the valve to close or open the suction jet pump directly.

According to another embodiment, a disturbance in the conveyance of the suction jet pump by the valve body arranged near the nozzle can be avoided in a simple way when the valve is arranged in the conveying line.

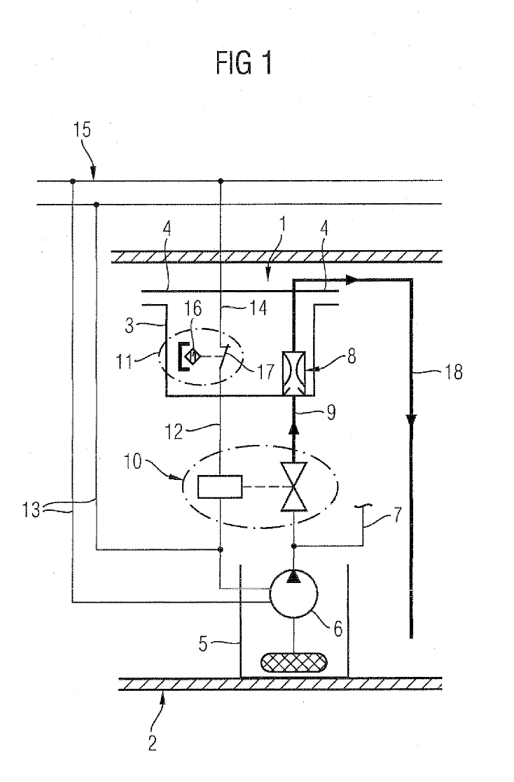

FIG. 1 shows a ventilation device 1 for a fuel container 2 of a motor vehicle, with a liquid trap 3 arranged in the upper region. Ventilation lines 4 lead from the liquid trap 3 to lateral regions of the fuel container 2. Furthermore, a baffle 5 with an electromotive fuel pump 6 is arranged on the bottom of the fuel container 2. The fuel pump 6 sucks in fuel from the baffle 5 and conveys it via a forward-flow line 7 to an internal combustion engine, not illustrated, of the motor vehicle. Arranged in the liquid trap 3 is a suction jet pump 8 which is connected via a conveying line 9 to the forward-flow line 7 of the fuel pump 6. Arranged in the conveying line 9 is an electrically switchable valve 10 which is connected via an electrical line 12 to a liquid-level limit switch 11 arranged in the liquid trap 3. The filling-level limit switch 11, the electrically switchable valve 10 and the fuel pump 6 are likewise connected via electrical lines 13, 14 to a power supply 15 of the motor vehicle. The filling-level limit switch 11 has an electrical contact 17 switchable by a float 16.

When a fuel filling level provided is overshot in the liquid trap 3, the float 16 is deflected and closes the electrical contact 17 of the filling-level limit switch 11. Consequently, the electrically switchable valve 10 is connected to the power supply 15, opens and releases the conveying line 9. The fuel pump 6 consequently conveys fuel as a propellant to the suction jet pump 8. The suction jet pump 8 subsequently sucks in accumulated fuel from the liquid trap 3 and conveys it via a discharge line 18 into the fuel container 2. Conversely, below the fuel filling level provided in the liquid trap 3, the electrically switchable valve 10 is not connected to the power supply 15, so that the suction jet pump 8 receives no fuel as a propellant and the entire fuel conveyed by the fuel pump 6 enters the forward-flow line 7.

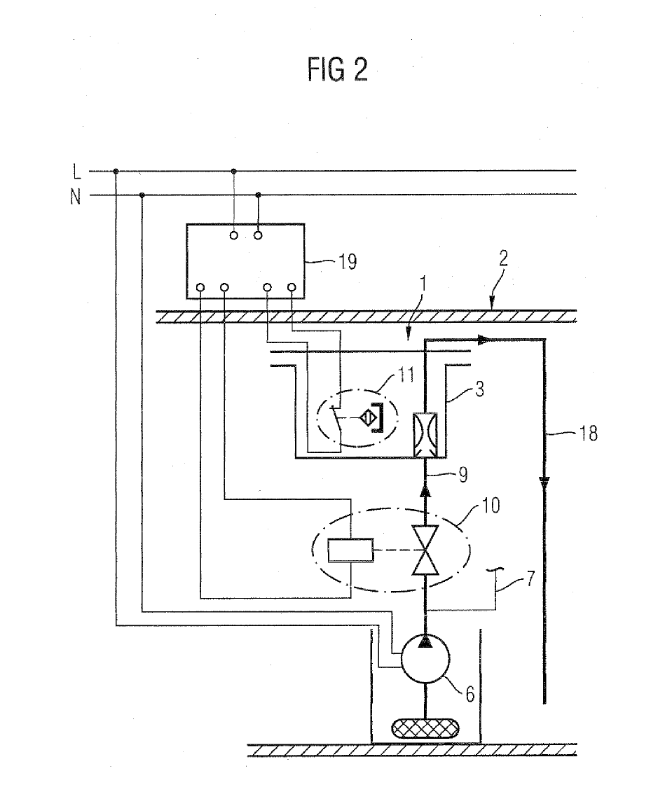

FIG. 2 shows a further embodiment of the ventilation device 1 which differs from that of FIG. 1 only in that the filling-level limit switch 11 arranged in the liquid trap 3 and the electrically switchable valve 10 are connected in each case to an electronic control unit 19. The electronic control unit 19 activates the electronically switchable valve 10, as described with regard to FIG. 1. Furthermore, with an appropriate control program, the electronic control unit 19 can, for example, prevent an opening of the valve 10 when, in operating states provided, the entire fuel conveyed by the fuel pump 6 is to be conveyed into the forward-flow line 7. Such operating states prevail, for example, when the internal combustion engine is started and at low temperatures. A time-controlled opening of the valve 10 is likewise possible, thus ensuring that the liquid trap 3 is emptied reliably whenever the valve 10 is switched.

FIGS. 1 and 2 illustrate diagrammatically the valve 10 outside the liquid trap 3. The valve 10 may, of course, also be arranged inside the liquid trap 3 and form with the suction jet pump 8 and/or the filling-level limit switch 11 a structural unit. In the case of a purely mechanical activation of the valve 10, moreover, in an alternative embodiment, not illustrated, no electrical lines 12, 14 for connecting the valve 10 and the filling-level limit switch 11 to the power supply 15 are required.

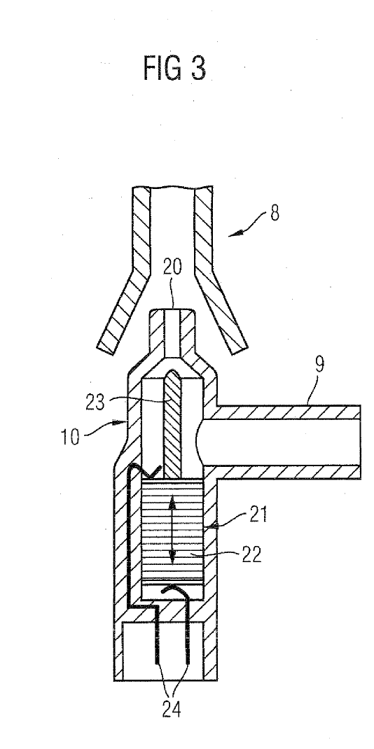

FIG. 3 shows a structural unit consisting of a nozzle 20 of the section jet pump 8 and of the electrically switchable valve 10. The electrically switchable valve 10 has an actuator 21 with a piezo-element 22. When current is applied to the piezo-element 22, a valve body 23 is moved away from the nozzle 20 of the section jet pump 8 and releases the connection of the suction jet pump 8 to the conveying line 9. Electrical contacts 24 serve for connecting the actuator 21 to the electrical lines 12 illustrated in FIGS. 1 and 2.

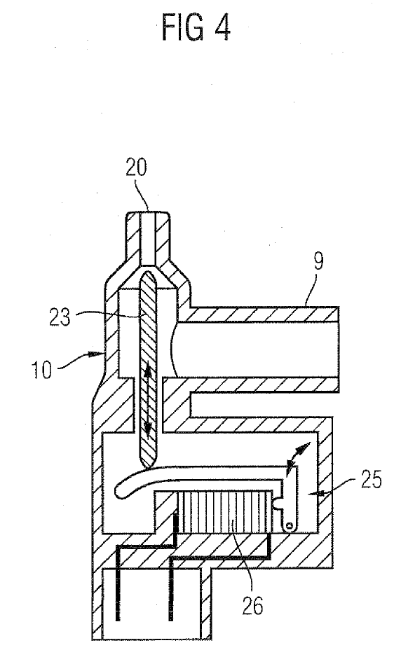

FIG. 4 shows a further embodiment of the structural unit consisting of a nozzle 20 of the suction jet pump 8 with the electrically switchable valve 10. As in the embodiment according to FIG. 3, the valve 10 has an actuator 25 with a piezo-element 26. The piezo-element 26 controls the movement of the valve body 23 via a lever 27.

FIG. 5 shows a further embodiment of the structural unit consisting of a nozzle 20 of the suction jet pump 8 with the electrically switchable valve 10. In contrast to the embodiments according to FIGS. 3 and 4, the valve 10 has an actuator 28 with an electromagnet 29. The electromagnet 29 moves a magnet 30 connected to the valve body 23. When current is applied appropriately, therefore, the valve body 23 is moved toward the nozzle 20 of the suction jet pump 8 or away from this.

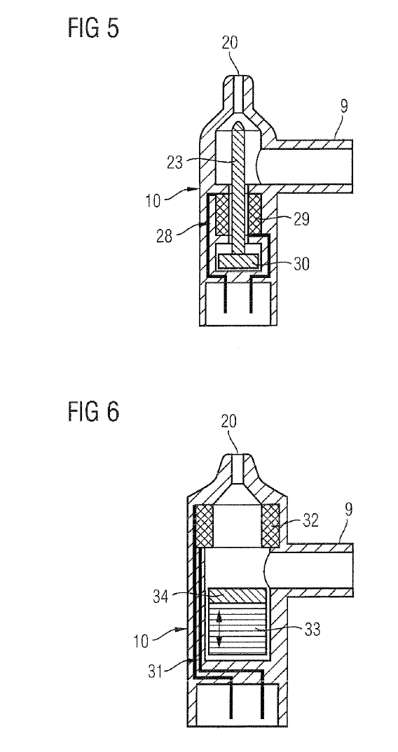

FIG. 6 shows a further embodiment of the structural unit consisting of a nozzle 20 of the suction jet pump 8 with the electrically switchable valve 10, in which the valve 10 has an actuator 31 with an electromagnet 32. When current is applied appropriately, a closing cylinder 33 with a magnet 34 can be moved into the conveying line 9 and consequently interrupt the conveyance of fuel to the nozzle 20 of the suction jet pump 8.

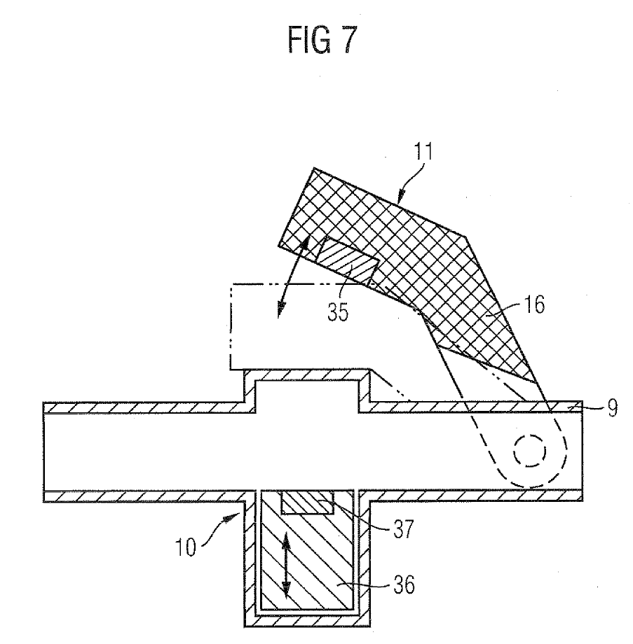

FIG. 7 shows a further embodiment of the ventilation device 1, in which the valve 10 is arranged in the conveying line 9 leading to the suction jet pump 8 and forms a structural unit with a filling-level limit switch 11. In contrast to the preceding embodiments, the valve 10 is connected to the float 16 and consequently has a purely mechanical function. The float 16 carries a magnet 35 which is mounted so as to be movable toward a wall of the conveying line 9. The valve 10 has a closing cylinder 36 guided longitudinally movably and having a magnet 37. When the float 16 lies on the wall, the closing cylinder 36 is pulled up and closes the conveying line 9. The position of the float 16 lying on the wall of the conveying line 9 is illustrated by dashes and dots in FIG. 7. Of course, that portion of the conveying line 9 which has the filling-level limit switch 11 must be arranged at the location provided in the liquid trap 3 illustrated in FIGS. 1 and 2.

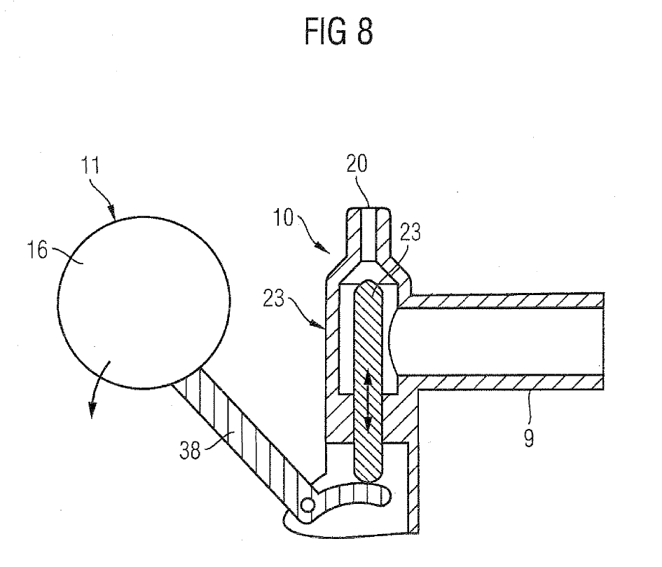

FIG. 8 shows a further embodiment of the ventilation device 1, in which the valve 10 forms a structural unit with the nozzle 20 of the suction jet pump 8 and with the filling-level limit switch 11. The float 16 of the filling-level limit switch 11 is connected via a lever 38 to the valve body 23 movable longitudinally displaceably toward the nozzle 20. As in the embodiment according to FIG. 7, hereto, the float 16 and the valve 10 must be arranged inside the liquid trap 3.

What is claimed is:

1. A ventilation device for a fuel container, comprising:
a liquid trap connected to at least one ventilation line,
a suction jet pump, arranged in the liquid trap, for the conveyance of fuel out of the liquid trap into the fuel container, and
a valve connected to the suction jet pump wherein the valve is switched as a function of the filling level of fuel in the liquid trap.

2. The ventilation device according to claim 1, wherein a filling-level limit switch for switching the valve is arranged in the liquid trap.

3. The ventilation device according to claim 1, wherein the filling-level limit switch has a float.

4. The ventilation device according to claim 1, wherein the valve is switched electrically.

5. The ventilation device according to claim 1, wherein the valve has an electric actuator and a valve body movable against a valve seat is connected to the actuator.

6. The ventilation device according to claim 1, wherein the electric actuator has an electromagnet or a piezo-element.

7. The ventilation device according to claim 1, wherein the filling-level limit switch has an electrical contact.

8. The ventilation device according to claim 1, wherein the electrical contact of the filling-level limit switch is arranged in series with the electric actuator of the valve.

9. The ventilation device according to claim 1, wherein the electrical contact of the filling-level limit switch and the electric actuator of the valve are connected to a common electronic control unit.

10. The ventilation device according to claim 1, wherein a baffle provided for mounting in the fuel container has an electromotive fuel pump, a conveying line of the fuel pump is connected to the suction jet pump, and wherein the baffle forms with the liquid trap a structural unit.

11. The ventilation device according to claim 1, wherein the valve body of the valve is guided movably toward a nozzle of the suction jet pump.

12. The ventilation device according to claim 1, wherein the valve is arranged in the conveying line.

13. A method for ventilating a fuel container, comprising the steps of:
connecting a liquid trap to at least one ventilation line,
conveying fuel out of the liquid trap into the fuel container by a suction jet pump, arranged in the liquid trap, and
switching a valve connected to the suction jet pump, as a function of the filling level of fuel in the liquid trap.

14. The method according to claim 13, wherein the filling-level limit switch has a float.

15. The method according to claim 13, wherein the valve is switched electrically.

16. The method according to claim 13, wherein the valve has an electric actuator and a valve body movable against a valve seat is connected to the actuator.

17. The method according to claim 13, wherein the electrical contact of the filling-level limit switch is arranged in series with the electric actuator of the valve.

18. The method according to claim 13, wherein the electrical contact of the filling-level limit switch and the electric actuator of the valve are connected to a common electronic control unit.

19. The method according to claim 13, wherein a baffle provided for mounting in the fuel container has an electromotive fuel pump, a conveying line of the fuel pump is connected to the suction jet pump, and wherein the baffle forms with the liquid trap a structural unit.

20. The method according to claim 13, wherein the valve body of the valve is guided movably toward a nozzle of the suction jet pump.
